(19) United States
(12) Patent Application Publication
(10) Pub. No.: US 2013/0151691 A1
(43) Pub. Date: Jun. 13, 2013

(54) Analyzing and Reporting Business Objectives in Multi-Component Information Technology Solutions

(71) Applicants: Michael P. Etgen, Cary, NC (US); William E. Hutson, Cary, NC (US); Christopher H. L. Wicher, Raleigh, NC (US)

(72) Inventors: Michael P. Etgen, Cary, NC (US); William E. Hutson, Cary, NC (US); Christopher H. L. Wicher, Raleigh, NC (US)

(73) Assignee: INTERNATIONAL BUSINESS MACHINES CORPORATION, Armonk, NY (US)

(21) Appl. No.: 13/315,454

(22) Filed: Dec. 9, 2011

(51) Int. Cl. G06F 15/173

(52) U.S. Cl. 709/224

(57) ABSTRACT

A method, data processing system, and computer program product for analyzing components in a network data processing system. A computer identifies a relationship of a set of components in the network data processing system with a function in an organization. The computer monitors a first set of metrics for the set of components over a time period, wherein the first set of metrics indicates a performance for the set of components. The computer monitors a second set of metrics for the function in the organization over the time period, wherein the second set of metrics indicates a use of the function in the organization. The computer selects a component in the set of components. The computer identifies an impact of the selected component on the second metrics for the function in the organization using the relationship and the second set of metrics. A user can provide comments regarding the impact.

### BACKGROUND

1. Field

The present disclosure relates generally an improved data processing system and in particular to a method and apparatus for analyzing components in a network data processing system. Still more particularly, the present disclosure relates to a method and apparatus for analyzing the effect of components in a network data processing system on a function in an organization.

2. Description of the Related Art

Businesses, government entities, and other organizations use information technology to solve business needs and to meet business objectives. In many organizations, the details of the technology used are not necessarily important to the personnel that use a network data processing system. The fact that different components in the network data processing system helps in performing functions in the organization is important. The components include, for example, databases, web servers, accounts receivable systems, order processing systems, and other components.

Businesses, government entities, and other organizations often have small information technology departments that are stretched thin to support a wide range of technologies in the company. There is usually a general knowledge of the relevance of a network data processing system in an organization. An organization will often upgrade existing components, add new components, and modify components in a network data processing system to increase the performance of functions in the organization.

### SUMMARY

The different illustrative embodiments provide a method, data processing system, and computer program product for analyzing components in a network data processing system. A computer identifies a relationship of a set of components in the network data processing system with a function in an organization. The computer monitors a first set of metrics for the set of components over a time period, wherein the first set of metrics indicates a performance for the set of components. The computer monitors a second set of metrics for the function in the organization over the time period, wherein the second set of metrics indicates a use of the function in the organization. The computer selects a component in the set of components. The computer identifies an impact of the selected component on the second metrics for the function in the organization using the relationship and the second set of metrics.

### BRIEF DESCRIPTION OF THE SEVERAL VIEWS OF THE DRAWINGS

FIG. 1 is an illustration of a component analysis environment in which illustrative embodiments may be implemented;

FIG. 2 is an illustration of a component analysis environment in which illustrative embodiments may be implemented;

FIG. 3 is a block diagram of a database table in accordance with an illustrative embodiment;

FIG. 4 is an illustration of a flowchart of a process for analyzing components in a network data processing system in accordance with an illustrative embodiment;

FIG. 5 is an illustration of a flowchart of a process for analyzing components in a network data processing system in accordance with an illustrative embodiment;

FIG. 6 is an illustration of a flowchart of a process for analyzing components in a network data processing system in accordance with an illustrative embodiment; and

FIG. 7 is an illustration of a data processing system in accordance with an illustrative embodiment.

### DETAILED DESCRIPTION

As will be appreciated by one skilled in the art, aspects of the illustrative embodiments may be embodied as a system, method or computer program product. Accordingly, aspects of the illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the illustrative embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electro-magnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction processing system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction processing system, apparatus, or device.

Program code embodied on a computer readable medium may be transmitted using any appropriate medium, including but not limited to wireless, wireline, optical fiber cable, radio frequency, etc., or any suitable combination of the foregoing.

Computer program code for carrying out operations for aspects of the illustrative embodiments may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the illustrative embodiments are described below with reference to flowchart illustrations and/or block diagrams of methods, apparatus (systems) and computer program products according to illustrative embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which are processed via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which are processed on the computer or other programmable apparatus provide processes for implementing the functions/acts specified in the flowchart and/or block diagram block or blocks.

The different illustrative embodiments recognize and take into that information technology personnel often have difficulty communicating to others in an organization the relevance and impact of different components in a network data processing system on the functions performed in the organization. The different illustrative embodiments recognize and take into account that identifying an impact of a component in a network data processing system on the use of a function in an organization may be desirable. The different illustrative embodiments recognize and take into account that if the impact of a component is known, changes to the component may be made to increase the performance of the function in the organization.

Thus, the different illustrative embodiments provide a method, data processing system, and computer program product for analyzing components in a network data processing system. A computer identifies a relationship of a set of components in the network data processing system with a function in an organization. The computer monitors a first set of metrics for the set of components over a time period, wherein the first set of metrics indicates a performance for the set of components. The computer monitors a second set of metrics for the function in the organization over the time period, wherein the second set of metrics indicates a use of the function in the organization. The computer selects a component in the set of components. The computer identifies an impact of the selected component on the second metrics for the function in the organization using the relationship and the second set of metrics. As used herein, “set of” refers to “one or more.” For example, a set of components is one or more components and a set of metrics is one or more metrics.

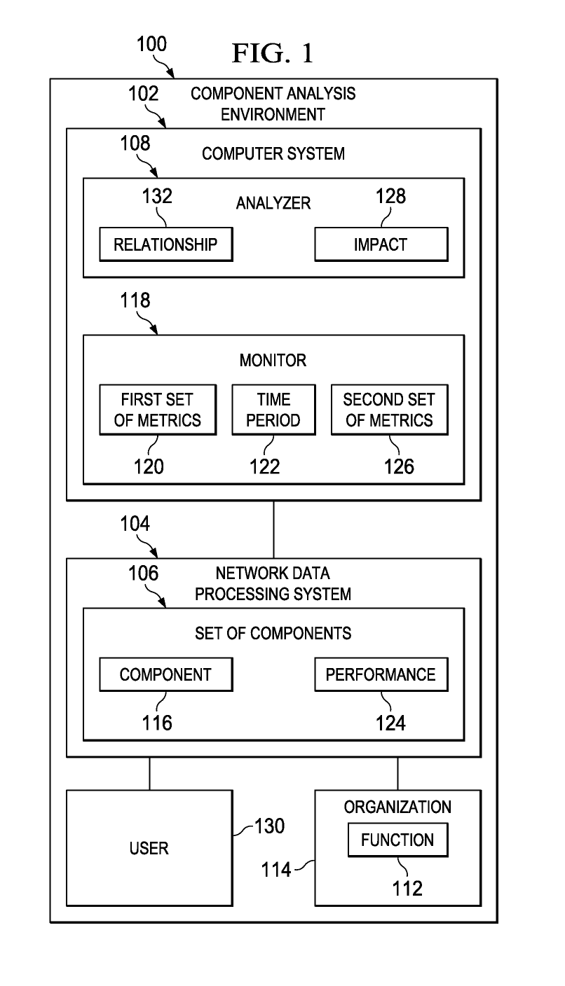

With reference to FIG. 1, component analysis environment 100 is depicted in accordance with an illustrative embodiment. As depicted, component analysis environment 100 is an example of computer systems in which the illustrative embodiments may be implemented.

In the depicted example, computer system 102 may comprise one or more computers, server computers, client computers, personal devices, or any other systems capable of running program code. In the depicted example, network of data processing system 104 includes set of components 106. Set of components 106 includes various devices and computers connected together within network data processing system 104. A network provides communications links between the various devices and computers connected together within set of components 106. Furthermore, computer system 102 communicates with network data processing system 104 via a communications medium. Examples of a communications medium that may be used includes, for example a network, wire and wireless transmission of information.

A component in set of components 106 can be a software application, a computer or other hardware, an operating system, middleware, a database, a group of software applications, a group of devices, a subset or portion of software applications, a subset or portion of a device, and a combination of hardware and software. Furthermore, a component in set of components 106 can be any other unit or sub-unit of hardware, software, or combination of hardware and software that is suitable for being physically or logically categorized as a unit. In some illustrative examples, computer system 102 may be included in network data processing system. In some illustrative examples, computer system 102 may be a component in set of components 106.

In the depicted example, computer system 102 includes analyzer 108, which maps set of components 110 to function 112 in organization 114. For example, analyzer 108 may map component 116 to function 112. Analyzer 108 may be software running on computer system 102. In some illustrative examples, analyzer 108 may be hardware. Component 116 is a component in set of components 106. Performing function 112 may accomplish one or more business objectives, such as tasks, goals, and action items for organization 116. For example, function 112 can be looking up the address of a customer and retrieving customer data. Set of components 106 is related to function 112. Set of components 110 may perform a portion of function 112 in these illustrative examples. Also, set of components 110 may be used when performing function 112 in these illustrative examples. For example, component 116 in set of components 110 may store customer addresses. In this illustrative example, component 116 may be used to perform one or more tasks such as retrieving and storing customer addresses used to perform function 112.

As depicted, monitor 118 monitors first set of metrics 120 over time period 122. Monitor 118 may be software running on computer system 102. In some illustrative examples, monitor 118 may be hardware. First set of metrics 120 indicates performance 124 for set of components 106. First set of metrics 120 are measurement results of performance 124 of set of components 106 over time period 122. The measurement results can be represented by numbers, characters, graphics, or any other value suitable for representing a measurement of performance 124 of set of components 106. Performance 124, as measured by monitor 118 can be health, speed, processing speed, data throughput, available memory, amount of memory used, amount of storage space used, amount of time to perform an activity by a component, and any other operation of set of components 106 suitable for being measured. First set of metrics 120 can be measurement results for one component, a portion of one component, multiple components, and all components in set of components 106. For example, first set of metrics 120 may indicate that component 116 in set of components 106 is saving data and retrieving data at a slow rate on a particular day.

Monitor also monitors second set of metrics 124 over time period 122. Second set of metrics 126 indicates a use of function 112. Second set of metrics 126 are measurement results of use of function 112 over time period 122. The measurement results can be represented by numbers, characters, graphics, and any other value suitable for representing a measurement of use of function 112. The use measured can be frequency of use, an amount of use during a specified time interval, number of users using function 112, identity of users using function 112, time of day in which the use occurs, reduction in use, increase in use, change in use, and any other use of function 112 suitable for being measured. Second set of metrics 126 can be measurement results for use of function 112 or use of a portion of function 112. For example, second set of metrics 126 may indicate that a small number of new customer addresses were saved in a on a particular a day.

In these illustrative examples, time period 122 may be contiguous or non-contiguous. Thus, monitor 118 may monitor first set of metrics 120 and second set of metrics 126 once and/or multiple times over a particular time span. For example, monitor 118 may monitor first set of metrics 120 and second set of metrics 126 at a first time and at a second time, and any number of times thereafter. In some illustrative examples, monitor 118 may monitor first set of metrics 120 and second set of metrics 126 at defined time intervals, such as every 5 minutes. In some illustrative embodiments, first set of metrics 120 and second set of metrics 124 may be stored in order to provide a historical perspective and record. In some illustrative embodiments, the older data in the historical record can be compared to more recent data in the historical record. The comparison can provide an indication of improvement, degradation, and change in performance 124 for one or more components in set of components 106. The comparison may also provide an indication of improvement, degradation, and change in use of function 112.

Component 116 in set of components may be selected. Selecting component 116 can be for purposes of identifying impact 128 of component 116 on second set of metrics 126. Component 116 may be selected by user 130, by computer system 102, by analyzer 108, monitor 118, and other any other component and person suitable for selecting component 116 in computer system 102.

In some illustrative examples, impact 128 of component 116 on second set of metrics 126 is identified using a relationship such as relationship 132 of set of components 106 with function 112. In this illustrative example, analyzer 108 maps set of components 106 to function 112 using relationship 132.

Set of components 106 has relationship 132 to function 112. For example, component 106 may have relationship 132 to function 112. As another example, a plurality of components in set of components 106 may have relationship 132 to function 112. As another example, component 116 may have relationship 132 to a plurality of functions, such as function 112 and one or more other functions. Thus, set of components 106 may have a one-to-one, one-to-many, and many-to-one relationship to function 112. Furthermore, relationship 132 may be other types of relationships known for associating components of a network data processing system to functions in an organization. In some illustrative embodiments, relationship 132 may be identified based upon a file or a database. The file may include a mapping of set of components 106 to a function 112. In some illustrative examples, analyzer 108 retrieves the file in order to identify relationship 132. In some illustrative examples, analyzer 108 searches a database in order to identify relationship.

Impact 128 of component 116 on second set of metrics 126 may be identified using relationship 132. In some illustrative embodiments, impact 128 of component 116 on second set of metrics 126 may be identified using first set of metrics 120 and second set of metrics 126. For example, identifying impact 128 may include comparing first set of metrics 120 to second set of metrics 126 over time period 122. In some illustrative embodiments, first set of metrics 120 and second set of metrics 124 for a first time period 122 may be compared to first set of metrics 120 and second set of metrics 126 for a second time period 122 in order to identify impact 128 of component 116 on second set of metrics 126.

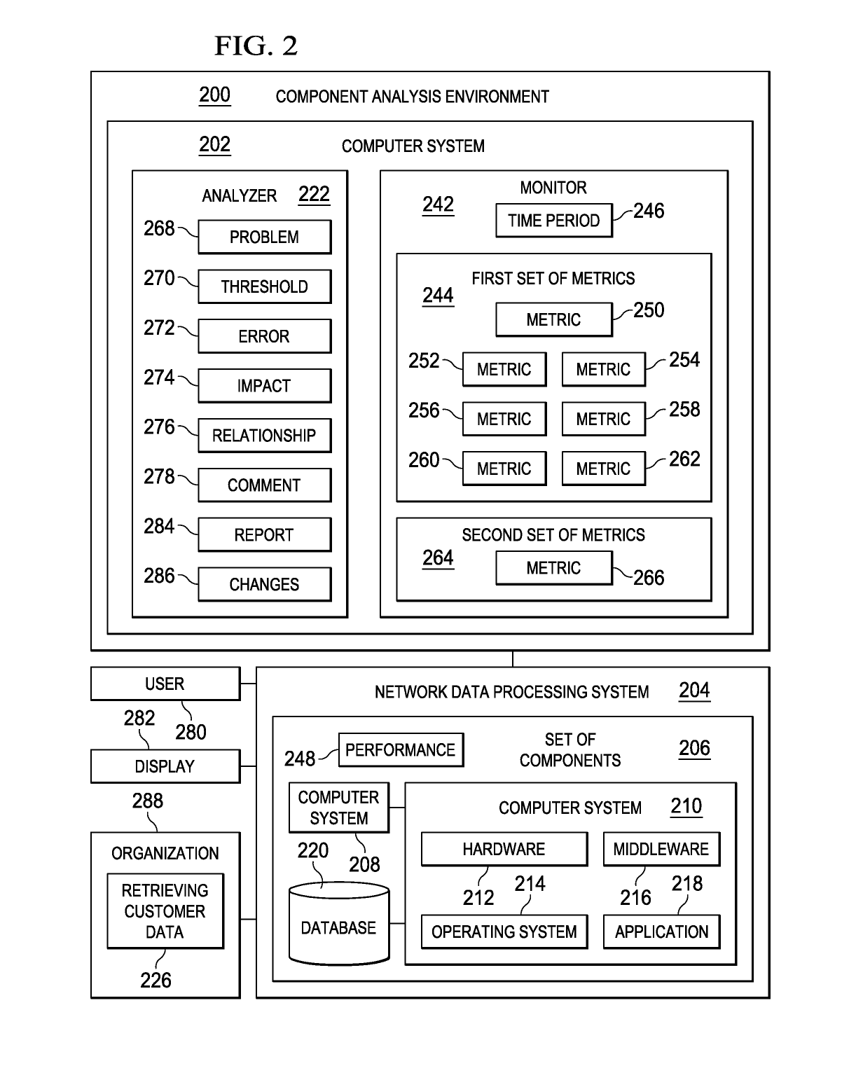

With reference now to FIG. 2, an illustration of a component analysis environment 200 is depicted in accordance with an illustrative embodiment. Component analysis environment 200 is an example of component analysis environment 100 of FIG. 1.

Computer system 202 may comprise one or more computers, server computers, client computers, personal devices, and any other systems capable of running program code. Computer system 202 is an example of computer system 102 of FIG. 1. In the depicted example, network data processing system 204 includes set of components 206. Network data processing system 204 is an example of network data processing system 104 of FIG. 1.

In the depicted example, set of components 206 includes computer system 208, computer system 210, hardware 212, operating system 214, middleware 216, application 218, and database 220. In the depicted example, hardware 212, operating system 214, middleware 216, application 218 are each a part of computer system 210. Computer system 208, computer system 210, and database 220 may include additional components.

Computer system 202 includes analyzer 222, which is an example of analyzer 108 of FIG. 1. Analyzer 222 maps set of components 206 to a function of retrieving customer data 226. Set of components 206 is related to the function of retrieving customer data 226. Retrieving customer data 226 is an example of function 112 of FIG. 1.

In the depicted example, monitor 242 generates first set of metrics 244 over time period 246. Monitor 242 is an example of monitor 118 of FIG. 1. First set of metrics 244 indicates a performance 248 for set of components 206. First set of metrics 244 are measurement results of the performance 248 of set of components 206 over time period 246. First set of metrics 244 includes metric 250, metric 252, metric 254, metric 256, metric 258, metric 260, and metric 262, which indicate the performance 248 for computer system 208, computer system 210, hardware 212, operating system 214, middleware 216, application 218, and database 220, respectively.

In the depicted example, monitor 242 also generates second set of metrics 264 over time period 246. Second set of metrics 262 includes metric 266, which indicates a use of the function, retrieving customer data 226. Metric 262 is a measurement result of use of the function, retrieving customer data 226. As in FIG. 1, time period 246 may be contiguous or non-contiguous.

In the depicted example, database 220 is selected in response to identifying problem 268 with database 220. In the depicted example, problem 268 is slow retrieval of data from database 220. In some illustrative examples, problem 268 may be identified by determining that metric 262 exceeds threshold 270. Threshold 270 may be a number that represents a measurement. For example, threshold 270 may specify an amount of time to retrieve an amount of data. In some illustrative examples, problem 268 may be identified by receiving error 272 associated with set of components 206. For example, problem 268 may be identified by receiving error 272 associated with database 220. For example, error 272 may indicate slow retrieval of data from database 220. As another example, error 272 may indicate database 220 is shut down or not responding. As another example, error 272 may indicate that a component hosting another component is not working. For example, a computer that hosts database 220may be shut down.

In the depicted example, impact 274 of database 220 on second set of metrics 264 is identified by analyzer 222 using relationship 276. In some illustrative embodiments, impact 274 of performance 248 of database 220 on retrieving customer data 226 may be identified using first set of metrics 244 and second set of metrics 264. For example, identifying impact 274 may include comparing first set of metrics 244 to second set of metrics 264 over time period 246. In some illustrative embodiments, first set of metrics 244 and second set of metrics 264 for a first time period 246 may be compared to first set of metrics 244 and second set of metrics 264 for a second time period 246 in order to identify impact 274 of database 220 on the use of retrieving customer data 226. For example, analyzer 222 may compare metric 260 to metric 266 at a first time period 246 and subsequently compare metric 260 to metric 266 at a second time period 246 to identify impact 274.

In some illustrative examples, comment 278 may be received by user 280 of network data processing system 204 regarding impact 274. For example, user 280 may enter comment 278 into display 282, which is a device configured for user 280 to enter comment 278 in response to problem 268. For example, comment 278 may be entered in response to user 280 being unable to perform a function or a business objective. As another example, user 280 may enter comment 278 in response to being delayed from performing a function. Comment 278 may include an explanation of impact 274 of problem 268. Comment 278 may include one or more words that represent user's 280 interpretation and feedback associated with first set of metrics 244, second set of metrics 264, and impact 274. Comment 278 may provide additional information associated with first set of metrics 244, second set of metrics 264, and impact 274. The additional information in comment 278 may not be present in first set of metrics 244, second set of metrics 264, and impact 274. For example, comment 278 may include information that is not clear and is not obvious based upon first set of metrics 244, second set of metrics 264, and impact 274. In some illustrative examples, comment 278 may include one or more inquiries of user 280. For example, comment 278 may include inquiries associated with first set of metrics 244, second set of metrics 264, and impact 274. For example, the inquiries may be directed to and addressed to other users, administrators, and anyone with the capability to answer inquiries and provide information associated with the inquiries to user 280. In some illustrative examples, comment 278 may include inquiries of user 280 regarding the meaning and explanation of first set of metrics 244, second set of metrics 264, and impact 274.

In some illustrative examples, responsive to identifying impact 274, analyzer 222 compares first set of metrics 244, second set of metrics 264, and comment 278 with industry benchmarks. Industry benchmarks may include industry benchmarks for first set of metrics 244, second set of metrics 264, and comment 278. For example, industry benchmarks may include average values and common values found in an industry associated with first set of metrics 244, second set of metrics 264. Industry benchmarks may also include words, phrases, and comments commonly found in an industry associated with first set of metrics 244, second set of metrics 264. Analyzer 222 then generates report 284 based upon the comparison. Responsive to generating report 284, analyzer 222 identifies changes 286 to set of components 206 to correct problem 268.

In some illustrative examples, responsive to modifying set of components 206 by analyzer 222 based upon changes 278, analyzer 222 identifies an improvement in first set of metrics 244 and second set of metrics 264. Analyzer 222 may then report the improvement. In some illustrative examples, analyzer 222 may generate a new report 276 to report the improvement. In some illustrative examples, responsive to modifying set of components 206 based upon changes 286, analyzer 222 receives a comment from a user of network data processing system 204. Comment 278 may describe observations by a user regarding the improvement due to changes 286. For example, comment 278 may be entered by user 280 in response to an improvement to a function or a business objective. As another example, user 280 may enter comment 278 in response to being able to perform a function in a shorter amount of time, with fewer errors, or more easily. For example, comment 278 may include an explanation regarding a correction of problem 268 that was identified in a previous comment. Analyzer 222 may then report the comment.

In some illustrative examples, responsive to identifying an improvement in first set of metrics 244 and second set of metrics 264 due to changes 286, analyzer 222 identifies an effect of the improvement on one or more business objectives of organization 288. In some illustrative examples, analyzer 222 identifies impact 274 on a business objective of organization 288 based upon identifying impact 274 of a component in set of components 206 on second set of metrics 264. For example, analyzer 222 may identify impact 274 on a business objective of organization 288 based upon identifying impact 274 of database 220 on second set of metrics 264.

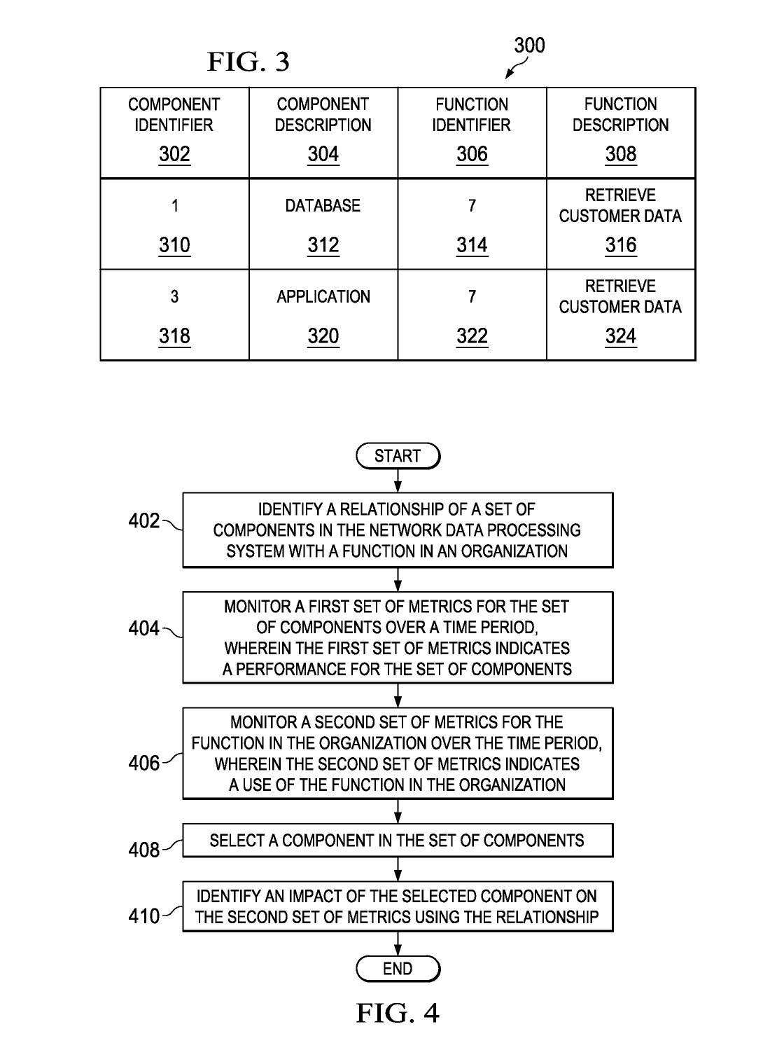

With reference now to FIG. 3, a block diagram of a database table 300 with data that maps components in a network data processing system to a function in an organization is depicted in accordance with an illustrative embodiment. In some illustrative examples, database table 300 may be stored in a database that is a component in a network data processing system of a component analysis environment, such as component analysis environment 200 in FIG. 2.

In this illustrative example, database table 300 includes a component identifier column 302 that associates components with a component identifier number, a component description column 304 that associates a description with the component identifier number, a function identifier column 306 that associates a function identifier number with the component identifier number, and a function description column 308 that associates a description with the function identifier number.

For example, a database component, such as database 220, may have an entry in database table 300 that includes a component identifier 310 of “1,” a component description 312 of “Database,” a function identifier 314 of “7,” and a function description 308 of “retrieve customer data.” Similarly, a software application component, such as application 218, may have an entry in database table 300 that includes a component identifier 318 of “1,” a component description 320 of “Database,” a function identifier 322 of “7,” and a function description 324 of “retrieve customer data.” Analyzer 222 may identify relationship 276 of database 220 and application 218 with the function of retrieving customer data 226.

In some illustrative examples, database table 300 may include additional fields that provide additional data regarding relationship 276 of database 220 and application 218 with the function of retrieving customer data 226. For example, additional fields may provide a type of relationship 276, a type of dependency of a function on a component, and a level and extent of dependency of a function on a component, wherein the level and extent may be assigned a number, percentage, or other value suitable for indicating a level and extent of dependency. For example, a level of “5” out of a maximum of “10” that is associated with component identifier 310 may indicate that the function of “retrieving customer data” depends on database 220, but the dependency is not critical. For example, a backup database may be available. However, if no backup database is available, then the level may be assigned a value of “10.” Other fields suitable for describing relationship 276 may be used. In some illustrative examples, additional functions may be associated with component identifier 310 and component identifier 318. In some illustrative examples, additional component identifiers may be associated with function identifier 314.

With reference now to FIG. 4, an illustration of a flowchart of a process for analyzing components in a network data processing system is depicted in accordance with an illustrative embodiment. The process illustrated in FIG. 4 may be implemented in a component analysis environment, such as component analysis environment 100 in FIG. 1. For example, the process may be implemented by computer system 102 in FIG. 1. In some illustrative examples, the process may be implemented by analyzer 108 and monitor 118 in FIG. 1.

The process begins by identifying relationship 132 of a set of components 106 in a network data processing system 104 with a function 112 (step 402). In some illustrative embodiments, relationship 132 may be contained in a file. The file may include a mapping of set of components 106 to function 112. In some illustrative embodiments, analyzer 108 retrieves the file in order to identify relationship 132. In some illustrative embodiments, analyzer 108 identifies relationship 132 based on data stored in a database and/or other storage mediums. In some illustrative embodiments, analyzer 108 may identify relationship 132 by collecting data from set of components 106 and determining relationship 132 based on the collected data.

The process monitors a first set of metrics 120 for the set of components 106 over a time period 122, wherein the first set of metrics 120 indicates a performance for the set of components 106 (step 404). The process monitors a second set of metrics 126 for the function 112 in organization 114 over the time period 122, wherein the second set of metrics 126 indicates a use of the function 112 in organization 114 (step 406).

The process then selects a component 116 in the set of components 106 (step 408). The process then identifies an impact 128 of the selected component 116 on second set of metrics 126 using relationship 132. (step 410). For example, identifying impact 128 of component 116 may include comparing a first metric in first set of metrics 120 to a second metric in second set of metrics 126 over time period 122, wherein the first metric indicates performance for component 116. In some illustrative embodiments, first set of metrics 120 and second set of metrics 124 for a first time period 122 may be compared to first set of metrics 120 and second set of metrics 126 for a second time period 122 in order to identify impact 128 of component 116 on second set of metrics 126. Thereafter, the process terminates.

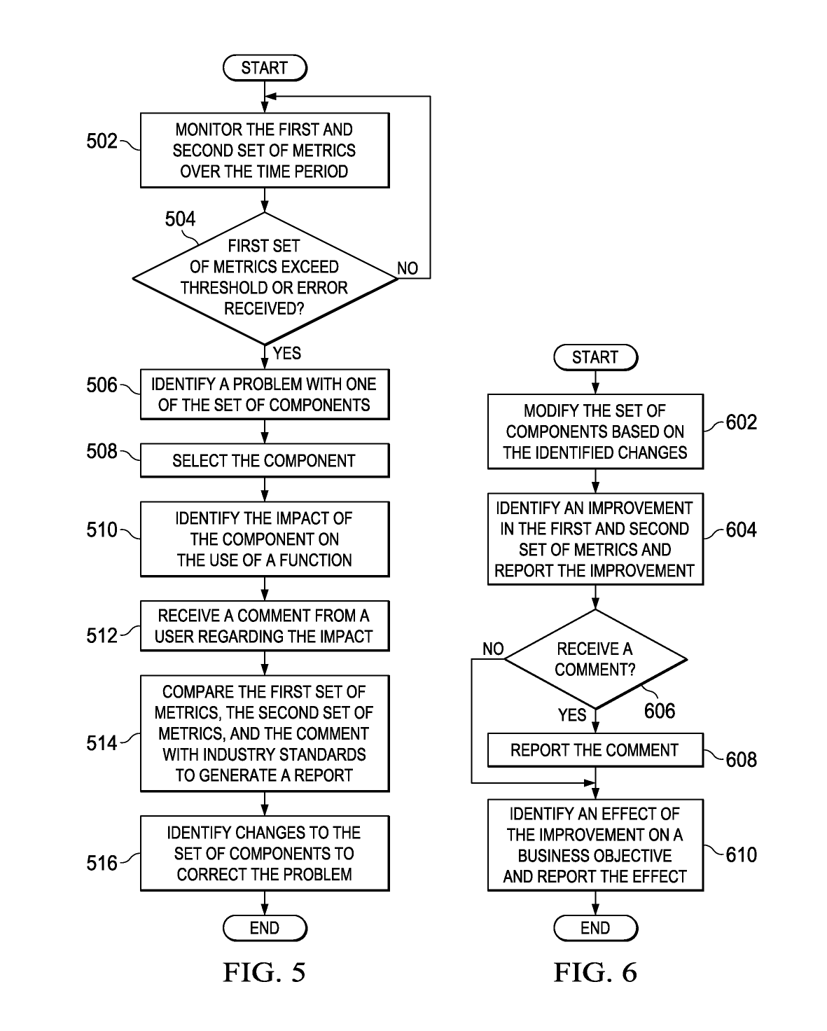

With reference now to FIG. 5, an illustration of a flowchart of a process for analyzing components in a network data processing system is depicted in accordance with an illustrative embodiment. The process illustrated in FIG. 5 may be implemented in a component analysis environment, such as component analysis environment 200 in FIG. 2. For example, the process may be implemented by computer system 202 in FIG. 2. In some illustrative examples, the process may be implemented by analyzer 222 and monitor 242 in FIG. 1.

The process begins by monitoring a first 244 and second 264 set of metrics over the time period 246 (step 502). Step 502 is an example of implementing steps 404 and 406 of FIG. 4. At step 504, the process determines whether the first set of metrics 244 exceeds a threshold 270 or whether an error 272 is received. If the first set of metrics 244 does not exceed a threshold 270 and no error 272 is received, the process returns to step 502. Returning to step 504, if the first set of metrics 244 exceeds a threshold 270 or an error 272 is received, the process continues to step 506.

The process then identifies a problem 268 with one of the set of components 206 (step 506). For example, problem 268 may be identified by determining that metric 262 exceeds threshold 270. Problem 268 may be metric 262 exceeding threshold 270. Threshold 270 may be a number that represents a measurement. For example, threshold 270 may specify an amount of time to retrieve an amount of data. In some illustrative examples, problem 268 may be identified by receiving error 272 associated with set of components 206. For example, problem 268 may be identified by receiving error 272 associated with database 220. For example, error 272 may indicate slow retrieval of data from database 220. Problem 268 may be slow retrieval of data from database 220. As another example, error 272 may indicate database 220 is shut down or not responding. Problem 268 may be database 220 is shut down or not responding. As another example, error 272 may indicate that a component hosting another component is not working. Problem 268 may be a component is not working properly and not working within component specifications. For example, a computer that hosts database 220 may be shut down. Problem 268 may be that the computer hosting database 220 is shut down.

The process then selects the component with the problem 268 (step 508). Step 508 is an example of implementing step 408 of FIG. 4. The process then identifies an impact 274 of the selected component on the use of the function 226 in organization 288 using relationship 276 and the second set of metrics 264 (step 510). The process then receives a comment 278 from a user regarding the impact 274 (step 512). The process then compares the first set of metrics 244, the second set of metrics 264, and the comment 278 with industry benchmarks to generate a report 284 (step 514). The process then identifies changes 286 to the set of components 206 to correct the problem 268 (step 516). Thereafter, the process terminates.

With reference now to FIG. 6, an illustration of a flowchart of a process for analyzing components in a network data processing system is depicted in accordance with an illustrative embodiment. The process illustrated in FIG. 6 may be implemented in a component analysis environment, such as component analysis environment 200 in FIG. 2. For example, the process may be implemented by computer system 202 in FIG. 2. In some illustrative examples, the process may be implemented by analyzer 222 and monitor 242 in FIG. 1.

The process begins by modifying the set of components 206 based on the identified changes 286 (step 602). The changes 286 may be identified, for example, in step 516 of FIG. 5. The process then identifies an improvement in the first 244 and second 264 set of metrics and reports the improvement (step 604). At step 606, the process determines whether a comment 278 is received. If a comment 278 is received, the process continues to step 608, where the process reports the comment 278. The process then continues to step 610. Returning to step 606, if a comment 278 is not received, the process continues to step 610. At step 610, the process identifies an effect of the improvement on a business objective and reports the effect of the improvement. Thereafter, the process terminates.

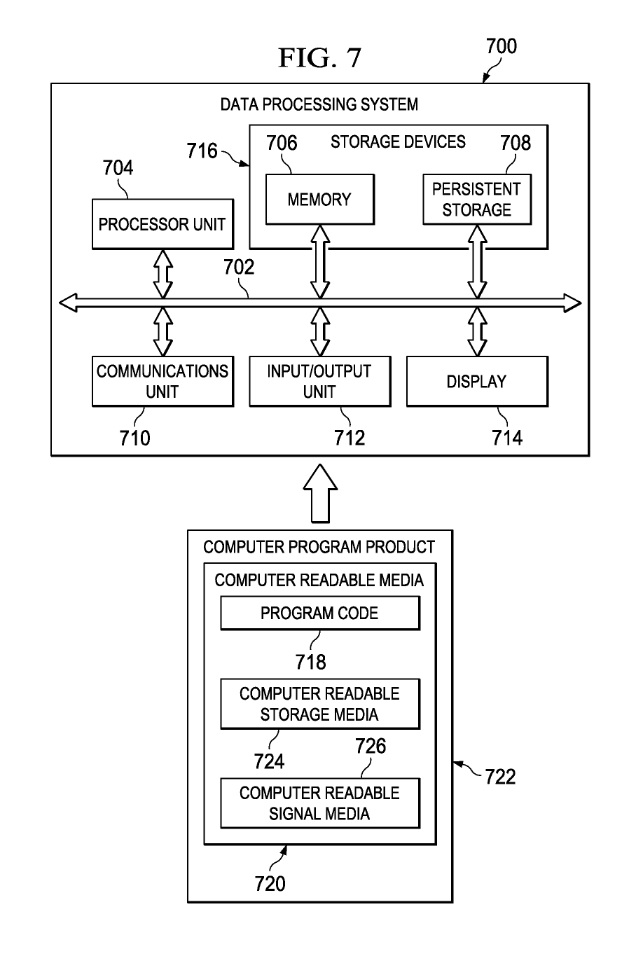

Turning now to FIG. 7, an illustration of a data processing system is depicted in accordance with an illustrative embodiment. In this illustrative example, data processing system 700 includes communications fabric 702, which provides communications between processor unit 704, memory 706, persistent storage 708, communications unit 710, input/output (I/O) unit 712, and display 714. Data processing system 700 is an example of one implementation for computer system 202, computer system 208, and computer system 210 in component analysis environment 200 in FIG. 2.

Processor unit 704 serves to run instructions for software that may be loaded into memory 706. Processor unit 704 may be a number of processors, a multi-processor core, or some other type of processor, depending on the particular implementation. A number, as used herein with reference to an item, means one or more items. Further, processor unit 704 may be implemented using a number of heterogeneous processor systems in which a main processor is present with secondary processors on a single chip. As another illustrative example, processor unit 704 may be a symmetric multi-processor system containing multiple processors of the same type.

Memory 706 and persistent storage 708 are examples of storage devices 716. A storage device is any piece of hardware that is capable of storing information, such as, for example, without limitation, data, program code in functional form, and/or other suitable information either on a temporary basis and/or a permanent basis. Storage devices 716 may also be referred to as computer readable storage devices in these examples. Memory 706, in these examples, may be, for example, a random access memory or any other suitable volatile or non-volatile storage device. Persistent storage 608 may take various forms, depending on the particular implementation.

For example, persistent storage 708 may contain one or more components or devices. For example, persistent storage 708 may be a hard drive, a flash memory, a rewritable optical disk, a rewritable magnetic tape, or some combination of the above. The media used by persistent storage 708 also may be removable. For example, a removable hard drive may be used for persistent storage 708.

Communications unit 710, in these examples, provides for communications with other data processing systems or devices. In these examples, communications unit 710 is a network interface card. Communications unit 710 may provide communications through the use of either or both physical and wireless communications links.

Input/output unit 712 allows for input and output of data with other devices that may be connected to data processing system 700. For example, input/output unit 712 may provide a connection for user input through a keyboard, a mouse, and/or some other suitable input device. Further, input/output unit 712 may send output to a printer. Display 714 provides a mechanism to display information to a user.

Instructions for the operating system, applications, and/or programs may be located in storage devices 716, which are in communication with processor unit 704 through communications fabric 702. In these illustrative examples, the instructions are in a functional form on persistent storage 708. These instructions may be loaded into memory 706 or run by processor unit 704. The processes of the different embodiments may be performed by processor unit 704 using computer implemented instructions, which may be located in a memory, such as memory 706.

These instructions are referred to as program code, computer usable program code, or computer readable program code that may be read and run by a processor in processor unit 704. The program code in the different embodiments may be embodied on different physical or computer readable storage media, such as memory 706 or persistent storage 708.

Program code 718 is located in a functional form on computer readable media 420 that is selectively removable and may be loaded onto or transferred to data processing system 700 and run by processor unit 704. Program code 718 and computer readable media 620 form computer program product 722 in these examples. In one example, computer readable media 720 may be computer readable storage media 724 or computer readable signal media 726. Computer readable storage media 724 may include storage devices, such as, for example, an optical or magnetic disk that is inserted or placed into a drive or other device that is part of persistent storage 708 for transfer onto a storage device, such as a hard drive, that is part of persistent storage 708. Computer readable storage media 724 also may take the form of a persistent storage device, such as a hard drive, a thumb drive, or a flash memory, that is connected to data processing system 700. In some instances, computer readable storage media 724 may not be removable from data processing system 700. In these illustrative examples, computer readable storage media 724 is a non-transitory computer readable storage medium.

Alternatively, program code 718 may be transferred to data processing system 200 using computer readable signal media 726. Computer readable signal media 726 may be, for example, a propagated data signal containing program code 718. For example, computer readable signal media 726 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 718 may be downloaded over a network to persistent storage 708 from another device or data processing system through computer readable signal media 726 for use within data processing system 700. For instance, program code stored in a computer readable storage medium in a server data processing system may be downloaded over a network from the server to data processing system 700. The data processing system providing program code 718 may be a server computer, a client computer, or some other device capable of storing and transmitting program code 718.

Program code 718 may be downloaded over a network from a remote data processing system to computer readable storage media 724 in data processing system 700. Furthermore, data processing system 700 may be a server data processing system, and program code 718 may be downloaded over the network to the remote data processing system for use in another computer readable storage media in the remote data processing system.

The different components illustrated for data processing system 700 are not meant to provide architectural limitations to the manner in which different embodiments may be implemented. The different illustrative embodiments may be implemented in a data processing system including components in addition to or in place of those illustrated for data processing system 700. Other components shown in FIG. 7 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

As another example, a storage device in data processing system 700 is any hardware apparatus that may store data. Memory 706, persistent storage 708, and computer readable media 720 are examples of storage devices in a tangible form.

In another example, a bus system may be used to implement communications fabric 702 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 706, or a cache, such as found in an interface and memory controller hub that may be present in communications fabric 402.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the invention is a method, data processing system, and computer program product for analyzing components in a network data processing system. A computer identifies a relationship of a set of components in the network data processing system with a function in an organization. The computer monitors a first set of metrics for the set of components over a time period, wherein the first set of metrics indicates a performance for the set of components. The computer monitors a second set of metrics for the function in the organization over the time period, wherein the second set of metrics indicates a use of the function in the organization. The computer selects a component in the set of components. The computer identifies an impact of the selected component on the use of the function in the organization using the relationship and the second set of metrics.

One or more of the illustrative embodiments take into the effect of a component in a network data processing system on a function or objective of an organization. Thus, problems can be identified and corrections to the problems can be implemented. The illustrative embodiments may provide a more efficient identification and resolution process. These results may save time and money.

For example, when a problem arises in a component, the impact of the problem on the use of a function can be identified. A computer identifies changes to a set of components to correct the problem. The computer identifies an improvement due to the changes. The computer identifies an effect of the improvement on a business objective. Thus, the process of identifying the impact of various components in a network data processing system can made much more efficient, allowing much faster responsiveness in correcting problems and identifying positive impacts upon an organization's business objectives. Furthermore, a vendor of software or hardware components may increase sales by demonstrating the positive impact of new components on functions and business objectives for an organization.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for analyzing components in a network data processing system, the method comprising:
identifying a relationship of a set of components in the network data processing system with a function in an organization;
monitoring a first set of metrics for the set of components over a time period, wherein the first set of metrics indicates a performance for the set of components;
monitoring a second set of metrics for the function in the organization over the time period, wherein the second set of metrics indicates a use of the function in the organization;
selecting a component in the set of components; and
identifying an impact of the selected component on the second metrics for the function in the organization using the relationship.

2. The method of claim 1, wherein selecting the component in the set of components comprises:
selecting the component in the set of components in response to identifying a problem with the component.

3. The method of claim 2, wherein the problem is identified by one of determining that the first set of metrics exceed a threshold and receiving an error associated with the set of components.

4. The method of claim 2 further comprising:
receiving a comment from a user regarding the impact.

5. The method of claim 4 further comprising:
responsive to identifying the impact, comparing the first set of metrics, the second set of metrics, and the comment with industry benchmarks to generate a report; and
responsive to generating the report, identifying changes to the set of components to correct the problem.

6. The method of claim 5 further comprising:
responsive to modifying the set of components based upon the identified changes, identifying an improvement in the first set of metrics and the second set of metrics; and
reporting the improvement.

7. The method of claim 6, wherein the comment is a first comment, and further comprising:
responsive to modifying the set of components based upon the identified changes, receiving a second comment; and
reporting the second comment.

8. The method of claim 6 further comprising:
responsive to identifying the improvement in the first set of metrics and the second set of metrics, identifying an effect of the improvement on a business objective; and
reporting the effect of the improvement on the business objective.

9. The method of claim 1 further comprising:
identifying an impact on a business objective of the organization based upon identifying the impact of the selected component on the use of the function in the organization.

10. A data processing computer system for analyzing performance for components in a network data processing system comprising:
a bus;
a communications unit connected to the bus;
a storage device connected to the bus, wherein the storage device stores program code; and
a processor unit connected to the bus, wherein the processor unit is configured to run the program code to identify a relationship of a set of components in the network data processing system with a function in an organization; monitor a first set of metrics for the set of components over a time period, wherein the first set of metrics indicates a performance for the set of components; monitor a second set of metrics for the function in the organization over the time period, wherein the second set of metrics indicates a use of the function in the organization; select a component in the set of components; and
identify an impact of the selected component on the second metrics for the function in the organization using the relationship.

11. The data processing computer system of claim 10, wherein in being configured to run the program code to select the component, the processor unit is configured to run the program code to select the component in the set of components in response to identifying a problem with the component.

12. The data processing computer system of claim 11, wherein the processor unit is configured to run the program code to identify the problem by one of determining that the first set of metrics exceed a threshold and receiving an error associated with the set of components.

13. The data processing computer system of claim 11, wherein the processor unit is configured to run the program code to receive a comment from a user regarding the impact.

14. The data processing computer system of claim 13, wherein the processor unit is configured to run the program code to:
compare the first set of metrics, the second set of metrics, and the comment with industry benchmarks to generate a report, in response to identifying the impact; and
identify changes to the set of components to correct the problem, in response to generating the report.

15. The data processing computer system of claim 14, wherein the processor unit is configured to run the program code to:
identify an improvement in the first set of metrics and the second set of metrics, in response to modifying the set of components based upon the identified changes; and
report the improvement.

16. The data processing computer system of claim 15, wherein the comment is a first comment, and wherein the processor unit is configured to run the program code to:
receive a second comment, in response to modifying the set of components based upon the identified changes; and
report the second comment.

17. The data processing computer system of claim 15, wherein the processor unit is configured to run the program code to:
identifying an effect of the improvement on a business objective, in response to identifying the improvement in the first set of metrics and the second set of metrics; and
reporting the effect of the improvement on the business objective.

18. A computer program product for analyzing performance for components in a network data processing system comprising:
a computer readable storage device;
program code, stored on the computer readable storage device, for identifying a relationship of a set of components in the network data processing system with a function in an organization;
program code, stored on the computer readable storage device, for monitoring a first set of metrics for the set of components over a time period, wherein the first set of metrics indicates a performance for the set of components;
program code, stored on the computer readable storage device, for monitoring a second set of metrics for the function in the organization over the time period, wherein the second set of metrics indicates a use of the function in the organization;
program code, stored on the computer readable storage device, for selecting a component in the set of components; and
program code, stored on the computer readable storage device, for identifying an impact of the selected component on the second metrics for the function in the organization using the relationship.

19. The computer program product of claim 18, wherein the program code for selecting the component in the set of components comprises:
program code for selecting the component in the set of components in response to identifying a problem with the component.

20. The computer program product of claim 19, wherein the problem is identified by one of determining that the first set of metrics exceed a threshold and receiving an error associated with the set of components.

21. The computer program product of claim 19 further comprising:
program code, stored on the computer readable storage device, for receiving a comment from a user regarding the impact.

22. The computer program product of claim 21 further comprising:
program code, stored on the computer readable storage device, for responsive to identifying the impact, comparing the first set of metrics, the second set of metrics, and the comment with industry benchmarks to generate a report; and
program code, stored on the computer readable storage device, for responsive to generating the report, identifying changes to the set of components to correct the problem.

23. The computer program product of claim 22 further comprising:
program code, stored on the computer readable storage device, for responsive to modifying the set of components based upon the identified changes, identifying an improvement in the first set of metrics and the second set of metrics, and
program code, stored on the computer readable storage device, for reporting the improvement.

24. The computer program product of claim 18, wherein the computer readable storage medium is in a data processing system, and wherein the program code is downloaded over a network from a remote data processing system to the computer readable storage medium in the data processing system.

25. The computer program product of claim 24, wherein the computer readable storage medium is a first computer readable storage medium, wherein the first computer readable storage medium is in a server data processing system, and wherein the program code is downloaded over the network to the remote data processing system for use in a second computer readable storage medium in the remote data processing system.
